(19) United States
(12) Patent Application Publication
(10) Pub. No.: US 2021/0014390 A1
(43) Pub. Date: Jan. 14, 2021

(54) SYSTEM AND METHOD FOR A MULTI-USER REMOTE CONTROLLABLE SAFETY CAMERA

(71) Applicant: Command Vision, Inc., North Tustin, CA (US)

(72) Inventors: Kurt Stabel, North Tustin, CA (US); Rick Crawford, North Tustin, CA (US); Michael Solano, North Tustin, CA (US)

(21) Appl. No.: 16/858,545

(22) Filed: Apr. 24, 2020

Related U.S. Application Data
(63) Continuation of application No. 16/144,767, filed on Sep. 27, 2018, now abandoned.
(60) Provisional application No. 62/565,030, filed on Sep. 28, 2017.

(51) Int. Cl. H04N 5/225; A42B 3/04; H04N 5/232; A42B 3/30; H04N 5/33

(52) U.S. Cl. CPC H04N 5/2252; A42B 3/042; H04N 5/23206; A62C 27/00; H04N 5/33; H04N 5/23245; A42B 3/30

(57) ABSTRACT

A remotely controllable wireless camera system that may be mounted on an emergency worker or on the emergency worker's helmet. The system includes a digital camera and an infrared camera. The system is connected to a network and live-streams video via the network and a server in real-time.

### CROSS REFERENCE TO RELATED APPLICATION

This application is a continuation of U.S. patent application Ser. No. 16/144,767, filed Sep. 27, 2018, which claims priority to U.S. Provisional Patent Application No. 62/565,030, filed Sep. 28, 2017, the disclosures of which are hereby incorporated by reference in their entireties.

### FIELD OF THE INVENTION

The claimed invention relates to safety cameras and more particularly to system and method for a multi-user remote controllable safety camera for use in high risk environments.

### BACKGROUND OF THE INVENTION

In today's world, public safety personnel are facing ever more complex emergencies and high risk incidents. Terrorism, inclement weather, fires, civil unrest and other high-profile incidents have changed the face of managing large-scale and routine incidents. Maintaining current situational awareness at an incident is an increasingly complex task and elevates the risk to both the public and the emergency responders. Currently, public safety commanders manage an emergency incident with only radio messages, experience and intuition. Often, an incident command post typically establishes an audio link with the firefighters using separate, non-integrated, systems for audio communication. For example, once the incident commander receives a report from a captain of the unit on the scene, he/she reads progress from the building or hazardous zone along with the reports from units. However the incident commander only communicates to the captain over a walkie-talkie system and cannot visually observe the interior of the scene due to the command post being sometimes located more than a block away from the incident. The ability for commanders to visualize the incident as it unfolds is clearly lacking.

It is therefore desirable to provide system and method for a real-time, bi-directional communication and interaction platform from location-based multi-user remote controllable safety camera for use in high risk environments, and that provide advantages heretofore unknown in the art.

### SUMMARY OF THE INVENTION

Provided herein are embodiments of a remotely controllable wireless camera system that may be mounted on an emergency worker or on the emergency worker's helmet. The system includes a digital camera and an infrared camera. The system is connected to a network and live-stream video via the network and a secured server.

In some embodiments, the system of the present disclosure may include: a wireless camera system, hardware and software systems that enable the camera system to be operated remotely (e.g., to view remotely), and connectivity options to operate the remote cameras. The camera system may include a casing, a remotely controllable wireless camera system housed in the casing. The wireless camera system may include a digital camera, an infrared camera, and one or more processors and non-transitory computer readable memory storing instructions that, when executed by the processor(s): operate the digital camera and the infrared camera to capture information at an emergency incident, record the captured information in a storage medium, transmit the captured information to a device at a designated location, or to multiple devices at multiple designated locations substantially simultaneously or simultaneously. In some embodiments, the wireless camera system may automatically switch the capture of information between the digital camera and the infrared camera based on condition at the incident. In some embodiments, the wireless camera system may capture information at the incident using the digital camera and the infrared camera simultaneously. By default, the wireless camera system may transmit the captured information in real-time.

Other features and advantages of the present disclosure will be or will become apparent to one with skill in the art upon examination of the following figures and detailed description, which illustrate, by way of examples, the principles of the present disclosure.

### BRIEF DESCRIPTION OF THE DRAWINGS

The present disclosure may be better understood by referring to the following figures. The components in the figures are not necessarily to scale, emphasis instead being placed upon illustrating the principles of the disclosure. In the figures, like reference numerals designate corresponding parts throughout the different views.

FIG. 1 illustrates an exemplary system of a multi-user remote controllable safety camera system, according to an embodiment of the present disclosure.

FIG. 2 illustrates a perspective front view of a multi-user remote controllable safety camera in an exemplary casing, according to an embodiment of the present disclosure.

FIG. 3A illustrates a front view of a multi-user remote controllable safety camera in the exemplary casing with a partial view of the internal components, according to an embodiment of the present disclosure.

FIG. 3B illustrates a simplified front view of a multi-user remote controllable safety camera in the exemplary casing with a partial view of the internal components, according to an embodiment of the present disclosure.

FIG. 4A illustrates a rear view of a multi-user remote controllable safety camera in the exemplary casing, according to an embodiment of the present disclosure.

FIG. 4B illustrates a simplified rear view of a multi-user remote controllable safety camera in the exemplary casing, according to an embodiment of the present disclosure.

FIG. 4C illustrates an exemplary cut-away view of a back panel of the exemplary casing for a multi-user remote controllable safety camera, according to an embodiment of the present disclosure.

FIG. 5 illustrates a left side view of a multi-user remote controllable safety camera in the exemplary casing, according to an embodiment of the present disclosure.

FIG. 6A illustrates a right side view of a multi-user remote controllable safety camera in the exemplary casing, according to an embodiment of the present disclosure.

FIG. 6B illustrates another right side view of a multi-user remote controllable safety camera in the exemplary casing, according to an embodiment of the present disclosure.

FIG. 7 illustrates an exemplary exploded view of a multi-user remote controllable safety camera in the exemplary casing, according to an embodiment of the present disclosure.

FIG. 8 illustrates an exemplary exploded view of a multi-user remote controllable camera assembly, according to an embodiment of the present disclosure.

FIG. 9 illustrates an exemplary user interface screen as viewed by an authorized user of the multi-user remote controllable safety camera system, according to an embodiment of the present disclosure.

FIG. 10 illustrates an exemplary user interface screen showing the inside view at a location of an emergency incident provided by the multi-user remote controllable safety camera system, according to an embodiment of the present disclosure.

FIG. 11 illustrates an exemplary Command Post/Center of the multi-user remote controllable safety camera system, according to an embodiment of the present disclosure.

### DETAILED DESCRIPTION

The below described figures illustrate the described invention and method of use in at least one of its preferred, best mode embodiment, which is further defined in detail in the following description. Those having ordinary skill in the art may be able to make alterations and modifications to what is described herein without departing from its spirit and scope. While this invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated. Therefore, it should be understood that what is illustrated is set forth only for the purposes of example and should not be taken as a limitation on the scope of the present invention.

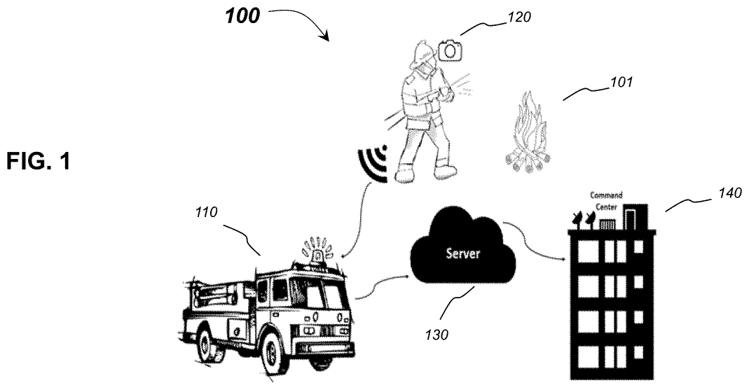

Turning to the drawings, FIGS. 1 to 11 illustrate exemplary embodiments of a wireless camera system that may be mounted on an emergency worker responding to an emergency, for example, on the front of the emergency worker's helmet. The system may be connected to a network, for example, an LTE network with satellite and redundancy. The network connection may be secured. The system may live-stream video via the secured network. The streams may be viewed from any device and at remote locations away from the emergency. The system (which may be referred to herein and in some drawings as Command Vision™) may allow a commander handling the emergency to have awareness of what is happening on the inside area of the emergency, e.g., inside a building, and allow for safety by giving eyes on the inside area of the emergency or areas normally not visible.

Generally, the system of the disclosure may include: a wireless camera system, a software system that enables the camera system to be operated remotely (e.g., to view remotely), an Incident Management software system, and connectivity options to operate the remote cameras. The camera system may include a casing, a remotely controllable wireless camera system housed in the casing. The wireless camera system may include a digital camera, an infrared camera, and one or more processors and non-transitory computer readable memory storing instructions that, when executed by the processor(s): operate the digital camera and the infrared camera to capture information at the incident, record the captured information in a storage medium, transmit the captured information to a device at a designated location, or to multiple devices at multiple designated locations substantially simultaneously or simultaneously. In some embodiments, the wireless camera system may automatically switch the capture of information between the digital camera and the infrared camera based on condition at the incident. In some embodiments, the wireless camera system may capture information at the incident using the digital camera and the infrared camera simultaneously. By default, the wireless camera system may transmit the captured information in real-time.

### Camera System

In some embodiments, the camera system may be either mounted to a mobile object (e.g., person, vehicle, drone) or a “fixed” camera system. The camera system to be mounted on a person may be a helmet-mounted camera system typically and “best method” may be to the front of a helmet, using a specially manufactured case. This camera system may operate inside of a structure that may be under high-risk conditions, e.g., fire conditions (called an IDLH, immediately dangerous to life or health). This camera system may have both a standard camera and a separate infrared (IR) camera (e.g., provided by FLIR™). A remote user may have the ability to “toggle” (or switch) back and forth between a standard camera image and IR, giving the viewer the ability to see heat signatures and potentially help locate a fire and/or direct personnel inside a structure. In some embodiments, the camera system may include a heat detecting laser device. This can be very helpful to identify, e.g., for personnel on the ground, the source of a fire or heat signatures.

In some embodiments, the helmet-mounted camera system may include function to automatically activate a streaming function. For example, when a fire company who is equipped with the helmet-mounted camera system is assigned to an incident through a CAD (computer aided dispatch) system, the camera system may automatically start streaming images back to a remote command center or to an Incident Commander assigned to that incident. In some embodiments, the helmet-mounted camera system may receive remote command to activate the streaming function.

In some embodiments, the camera system may include two separate platforms, non-streaming and streaming (live video feed that can be used by one or more remote users). The non-streaming version may function in substantially the same manner as the streaming version, but it may just record events to be viewed at a later time. In some embodiments, the main function of this camera system is the ability of the camera to record primarily in “regular” mode (e.g., as human naked eye functions). But, if the wearer enters an incident area with condition adverse to the “regular” mode, e.g., a smoky or extremely low-light environment, the IR function may take over and will continue to record in this mode. As such, the camera system provides a function that may determine (“think for the wearer”) and automatically switch between normal mode and IR mode. In other words, the camera system may determine to automatically switch the capture of information between the digital camera and the infrared camera based on the condition at the incident. In some embodiments, a sensor may provide input to trigger the switch. In some embodiments, image processing may determine whether to switch.

In some embodiments, the fixed camera system (which may include a different case design from the helmet-mounted camera system described above, but similar in function) may have the ability to be quickly mounted inside of a structure to remotely monitor the location without the need for personnel to monitor the camera and recording device. This is valuable, for example, when a police entry team or bomb squad needs to monitor a location and cannot place personnel at a fixed location. Or, possibly a fire company may leave a camera at the door of a structure where they made entry into a building. This may again allow command personnel not on scene to monitor the location.

### Software System to Remotely View the Video Streams

In some embodiments, the present disclosure may include a software package that can be downloaded as an App and/or a package that may reside on a desktop computer. If a user (for example, a Battalion Chief) has downloaded the app, he/she may be able to quickly click on any active fire incident type and remotely view that incident from any company who is on scene that is equipped with a helmet-mounted camera system.

In some embodiments, the software packages may access any video stream and play back the incident that may have happened shortly (e.g., minutes) before (even if the user was not actively viewing the incident). This may allow a viewer to “catch up” with what has transpired at an incident with video that was developed at the incident. This may be used as a critical tool to quickly obtain incident briefings which will likely be more powerful and relevant, for example, versus obtaining second hand information from a third party.

In some embodiments, the software package may have the ability to let an administrator assign user levels, e.g., pertaining to viewers who may not be a user of the system. This may be useful to outside agencies when responding to a multi-agency incident. For example, a plane crash or a terrorist incident requiring a large number of personnel and different departments. Potentially the main platform user/administrator (e.g., Los Angeles Fire Department) may assign view only user rights to, e.g., Culver City Fire and Police Department for use by their dispatch center when responding to a large-scale terrorist incident at, e.g., a location in Culver City. This will allow multiple agencies to interact more safely and effectively at emergencies.

### Incident Management Software System

In some embodiments, the present disclosure may include Incident Management (IM) software system that may allow an Incident Commander (IC) to quickly assign resources to specific tasks at large-scale incidents. In some exemplary operations, the IM system may automatically populate an image of the incident address (e.g., both “street view” and satellite view from Google Earth™). Then the IC may drag and drop units responding to the incident (e.g., overlaid on the Google Earth image). Concurrent with this, a desktop software user (e.g., residing at a dispatch center) may simply click on the companies that have already been placed at the incident and then may click into their video feed from the incident. Typically, the IC that is on-scene and in control of the incident manages this task, but the remote user at the dispatch or command center may be viewing the placement of companies and resources at an incident. This may allow unprecedented live intel from an incident as it unfolds. It may also improve company accountability and improve safety, as multiple individuals may be informed as to the location and task assigned to resources and personnel at an incident. This may be applicable, e.g., to both the fire and police departments. The system may also be utilized in areas such as offshore oil exploration or anywhere where multiple teams are working and a central location may want to be able to obtain critical “real-time” information of working conditions.

In some embodiments, the IM software system may be a separate stand-alone system.

### Connectivity Options to View Via Remote Cameras

In some embodiments as described herein, the camera system of the disclosure may include two platforms, one platform is app or phone based and one is desktop based, which may be more robust. In some embodiments, the desktop based camera system may be enabled through a cloud-based incident archiving and retrieval system. This may allow high level administrators and department managers the ability to review past significant incidents. This may be an important training tool, as past incidents can be reviewed and strengths can be emphasized. Conversely, potentially deficient areas can be identified and training programs can be implemented accordingly. Liability can be mitigated as past incidents have been recorded in the cloud and are correspondingly saved in accordance with the dispatch system as dictated by the user and/or department.

In some exemplary implementations, the wireless camera system may be a game changing system for fire departments as it may enhance safety, decision making and cutting-edge training scenarios. Commanders may no longer have to rely solely on radio transmissions to gain situational awareness. This new decision making tool may change emergency incident management and become a standard tool of commanders. Law enforcement may use the wireless camera system to handle high-risk situations such as active shooters, terrorism, SWAT and bomb squad incidents. Other exemplary uses may include construction and mining, enclosed tank inspections, underground mining operations, tunneling, heavy rigging, etc., and anywhere it might be beneficial to have a supervisor/safety officer directly seeing what the wearer of the wireless camera is doing in real time. The storage of the cameras may also be downloaded at the conclusion of an incident and reviewed post incident.

Besides the above exemplary implementations, the wireless camera system may be adaptable to many hazardous industries that require visual monitoring. For example, rail, oil, mining, government and military are some of the many industries in which the wireless camera system may be used. Other uses are also contemplated.

Turning to FIG. 1, an exemplary system 100 of the wireless camera system of the disclosure is shown, according to an embodiment of the present disclosure. FIG. 1 also illustrates exemplary transmission and data flow among the various systems and devices.

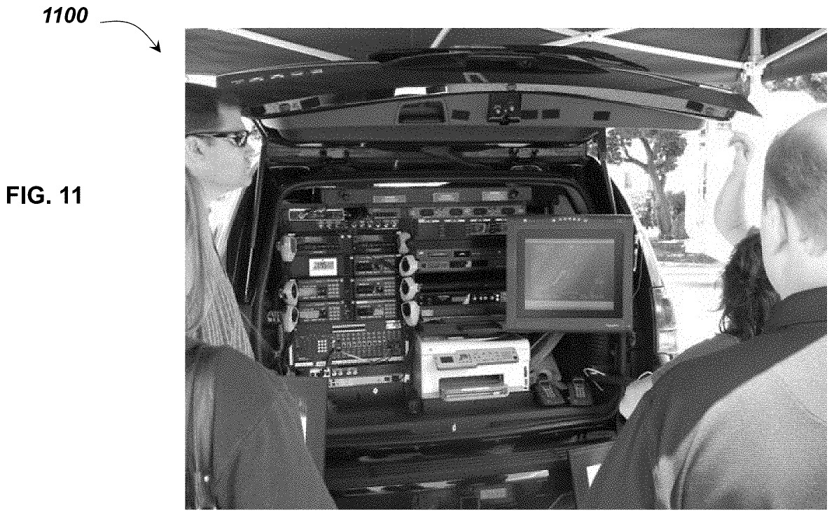

In an exemplary scenario, when an emergency 101 occurs, the public notifies fire and police agencies by calling 911 and communicates with a dispatcher (not shown), who obtains vital information such as address, phone number of the caller and a brief description of the emergency. The dispatcher may create the appropriate type of call by inputting the information into a dispatch computer. The dispatch computer usually has pre-determined calculations programmed to handle most emergencies. For example, the calculations may allow for a pre-selected number of emergency vehicles 110, such as fire trucks and ambulances, to be selected based on their proximity to the address provided by the caller. Upon dispatch, the list of emergency vehicles 110, e.g., fire trucks and ambulances, (known an “assignment”) will be sent an alarm to respond to the address provided and the resources will also have information sent to an onboard computer on the firefighting vehicles and ambulances. The assignment 110 may have a supervisor or command officer who will ultimately be in charge of the incident 101. The command officer (known as the “Incident Commander” or IC) arrives at the scene and gives orders as part of tactics and strategy to abate the emergency 101. When issuing orders to the assignment, the Incident Commander may receive reports from the assignment as to the progress of their task. With current technology, this is done via bi-directional radio communication only. The Incident Commander is often times more than a block away from the emergency 101, at a position known as a Command Post or Command Center 140 (see, e.g., Command Post 1100 in FIG. 11). Depending on the arrival sequence of the assignment 110, the Incident Commander may position him/herself to see the emergency from the most advantageous position. However, he/she cannot see either all sides, or the inside of the building and rely solely on reports from the resources on the assignment 110. The Incident Commander relies on his/her experience to make split second and sometimes, dangerous decisions. In the exemplary system 100, the wireless camera system 120 of the present disclosure may, among other benefits, assist the Incident Commander with decision making by providing a view of real time images and video of the emergency 101.

In some embodiments, the wireless camera system 120 may allow users at a single location, or even multiple users at different locations the ability to remotely view a live video stream (or multiple video streams generated from multiple wearers/cameras at one location) from the camera system 120, for example, mounted to a helmet or a fixed camera that can be temporarily and quickly “put up” (attached to a wall, doorway, etc.). The camera system 120 may connect to a network with a secure link to live stream the video. This can be accessed by any mobile device (mobile phone, iPad, etc.), wearable device, or desktop computer that is either network enabled or directly connected to the video stream (this may come into play where an agency directly broadcasts the stream over its own proprietary network (may come into play with certain government or public safety agencies). As such, the network may be the Internet, a cellular-based wireless network, a satellite network, and/or a proprietary network.

In some embodiments, the wireless camera system 120 may also have the ability to be integrated into a “backend” incident command software system. Taking the video feeds described above and linking them with an incident 101 (for example, a structure or brush fire with a fire department, a bomb threat or terrorist incident with a police department, and the like) will give users/viewers (typically a commanding officer at a remote location/Command Center 140) real time personnel accountability information, damage assessment, risk mitigation intelligence (“intel”) to order or place additional resources, remove personnel from dangerous situations, etc.

In some embodiments, the camera system 120 may develop the video feed using both a “regular camera” (e.g., digital camera developing an image that humans typically see with naked eye) and an infrared (IR), or thermographic camera. The remote viewer may have the ability to choose to view both images or just one image (for example, just the IR image in cases of heavy smoke conditions inside a burning building, or nighttime darkness during a police operation).

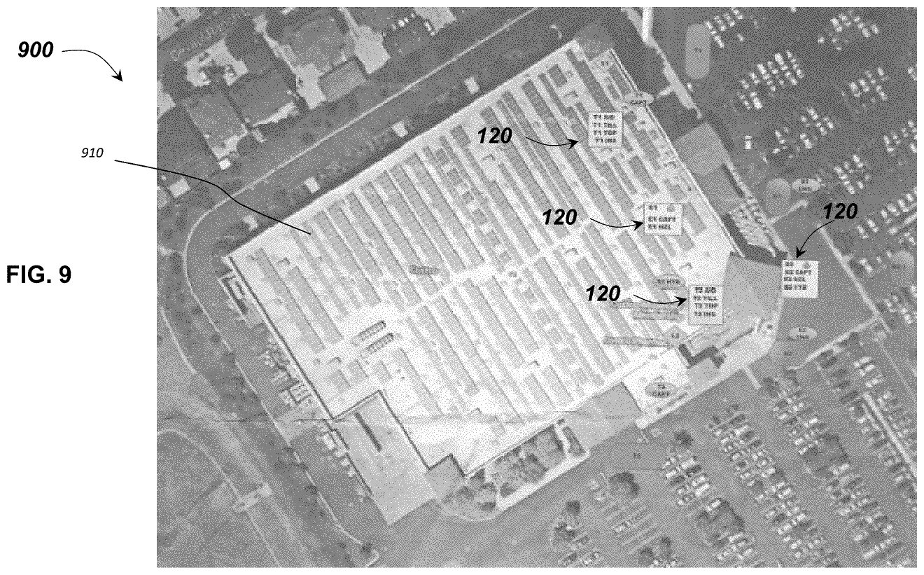

In some embodiments, the camera system 120 may be integrated into an existing fire department dispatch computer system. Upon dispatch, information may be sent to all camera systems designated as part of the incident 101. Each camera system may have an identifier such as a number or coded identifier, which may be programmed into the dispatch computer. This may allow information to be transmitted to specific camera system(s) designated as part of the emergency 101. Upon receiving a call and sending a dispatch, the system may send the dispatch information such as a list of resources, ambulances and command personnel to an application in a mobile device. When the application is opened, the first screen may display photos or video of the location of the dispatch (see, e.g., location 900 in FIG. 9). The user may be able to tap the screen and go to a visual display from the camera system 120, for example, mounted on or within the fire helmet of the designated person (for example, the captain).

In some embodiments, the camera system 120 may be remotely controlled. Typically, the list of resources at an incident will each have an identifier. The identifiers may be shown on a user interface screen (see, e.g., screen 900 in FIG. 9). The incident commander may be able to advantageously tap on the identifier and turn on (or off) the camera(s) of the camera system 120, or control other functions of the camera system 120 remotely. Often, while responding to the scene of an emergency, it is a highly stressed and dynamic environment and it is often chaotic and very easy for a wearer of the system to forget to turn the camera on.

The camera system 120 may automatically begin or may be remotely activated to begin to transmit and record. The transmission may be wireless and connected to the network (e.g., secured cellular and/or satellite network) via wireless hardware and software embedded in the camera system 120. In some exemplary operations, the transmission may follow the path from the camera system 120 to a modem/device mounted in a command vehicle or an emergency vehicle 100 (e.g., a fire truck) and then boosted to a cellular network and then to a secured cloud-based server 130 and then sent to Command Center 140, and/or to mobile devices at any remote location. This may allow the transmission feed to be recorded and stored.

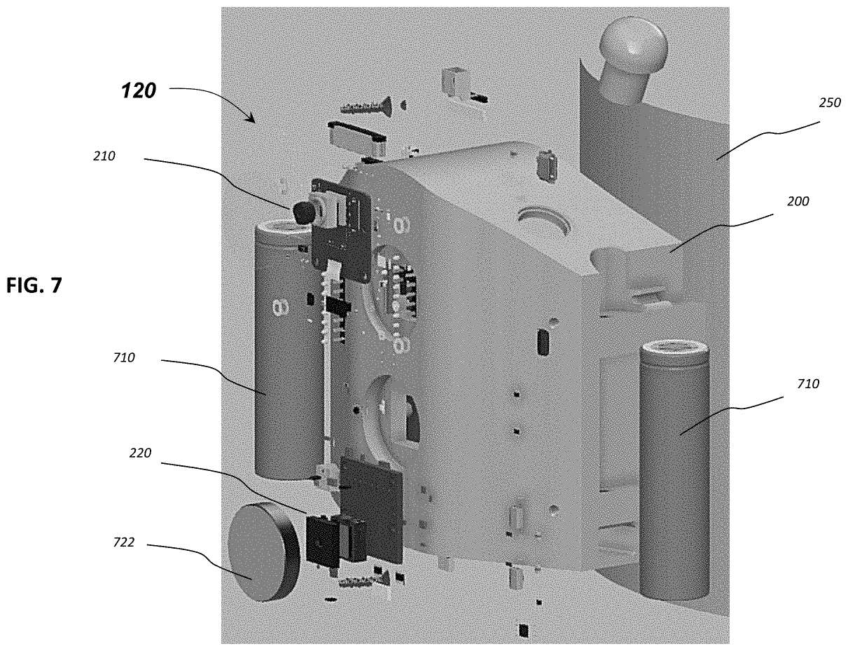

In some embodiments, the components of the camera system 120 may include, among others, an on/off button to manually be turned on (e.g., in the event of remote turn on failure), a charging port for one or more battery, thermal imaging, 360 degree viewing, precision location and tracking information including building height and depth, audio communication and recording, and camera lens. FIG. 7 shows some exemplary electronic components of the camera system 120, according to an embodiment of the present disclosure.

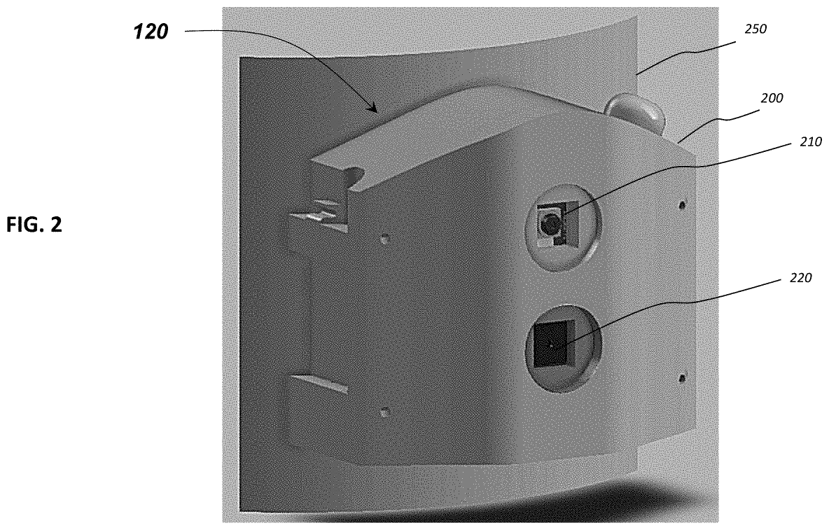

Turning to FIG. 2, an exemplary perspective view of the camera system 120 in an exemplary casing 200 is illustrated, according to an embodiment of the present disclosure. The camera system 120 may include a camera 210 (e.g., a digital camera), and an IR camera 220. The camera system 120 is shown mounted on a structure 250, e.g., a helmet.

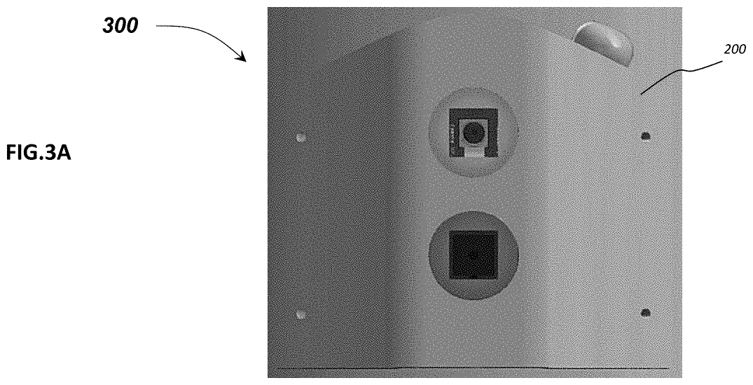

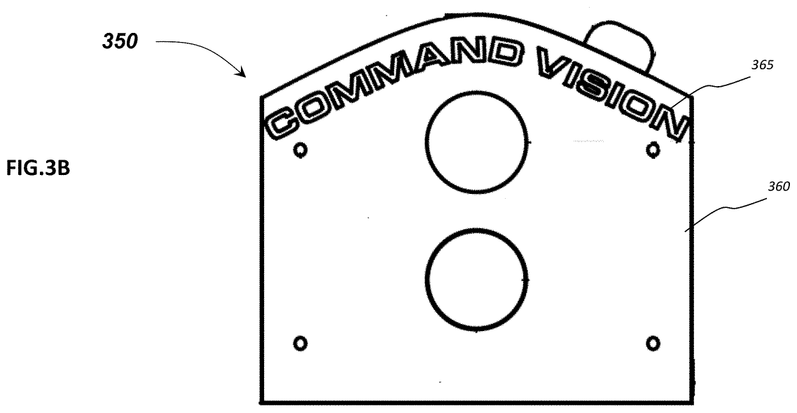

FIG. 3A illustrates an exemplary front view 300 of the camera system 120 in the exemplary casing 200, according to an embodiment of the present disclosure.

FIG. 3B illustrates an exemplary front view 350 of the camera system 120 in an exemplary casing 360, with optional branding 365 (e.g., COMMAND VISION™), according to an embodiment of the present disclosure.

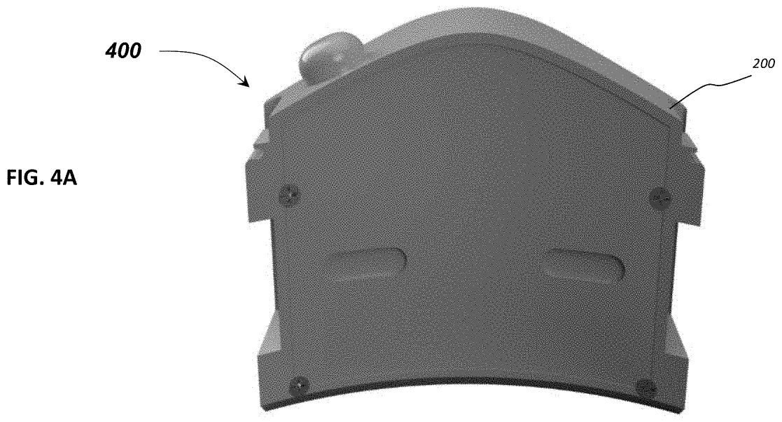

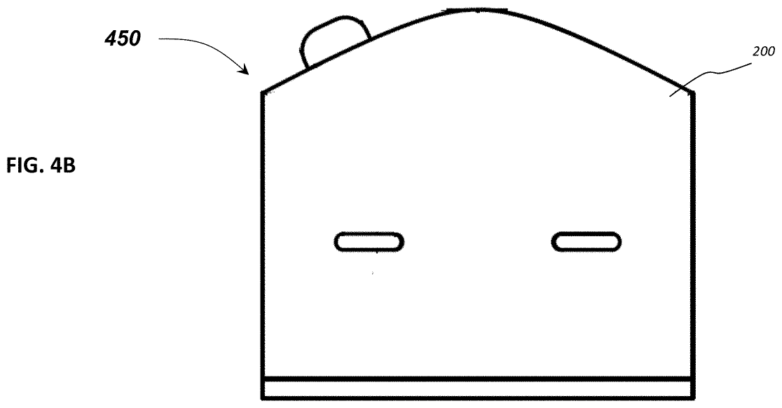

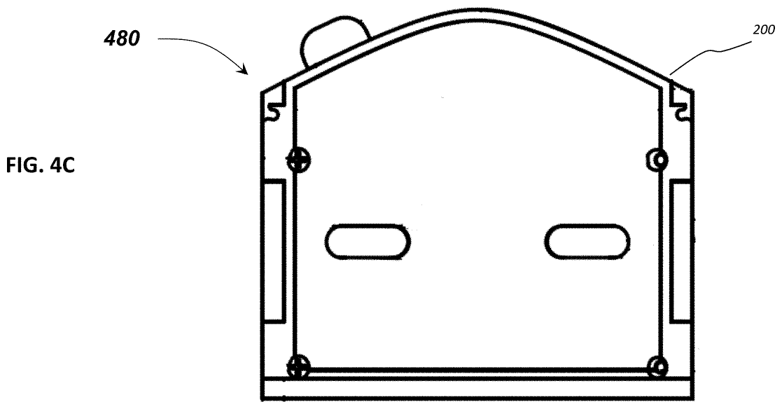

FIG. 4A illustrates an exemplary rear view 400 of the camera system 120 in the exemplary casing 200, according to an embodiment of the present disclosure.

FIG. 4B illustrates another exemplary rear view 450 of the camera system 120 in the exemplary casing 200, according to an embodiment of the present disclosure.

FIG. 4C illustrates an exemplary cut-away (sectional) rear view 480 of the exemplary casing 200, according to an embodiment of the present disclosure.

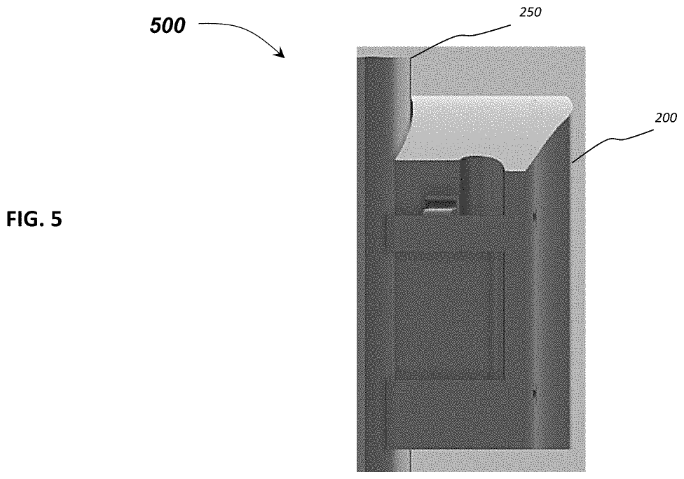

FIG. 5 illustrates an exemplary left side view 500 of the camera system 120 in the exemplary casing 200, mounted on the structure 250, according to an embodiment of the present disclosure.

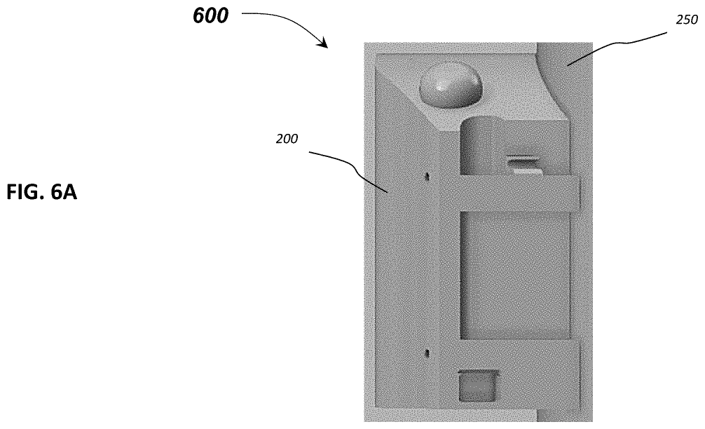

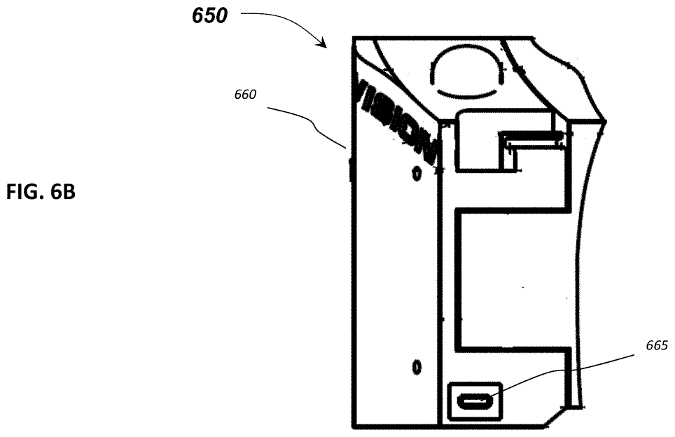

FIG. 6A illustrates an exemplary right side view 600 of the camera system 120 in the exemplary casing 200, mounted on the structure 250, according to an embodiment of the present disclosure.

FIG. 6B illustrates an exemplary right side view 650 of the camera system 120 in an exemplary casing 660, according to an embodiment of the present disclosure. In some embodiments, the casing 660 may include opening/receptacle 665 for one or more connectors. The connectors may provide connection for power, charging, communication, data transfer, etc. The connectors may be in suitable forms such as USB, HDMI, etc.

FIG. 7 illustrates an exemplary exploded view of the camera system 120, including partial view of some of the electronic components of the system, according to an embodiment of the present disclosure. The electronic components may include processor(s), memory, data storage, an operating system, input/output interfaces, a network interface all known in the art, etc. The electronic components may include at least one processor, and non-transitory computer readable memory for storing program and software instructions executable by the processor to perform the methods and features described in the present disclosure. Other components may include batteries 710, digital camera 210, IR camera 220 and lens 722.

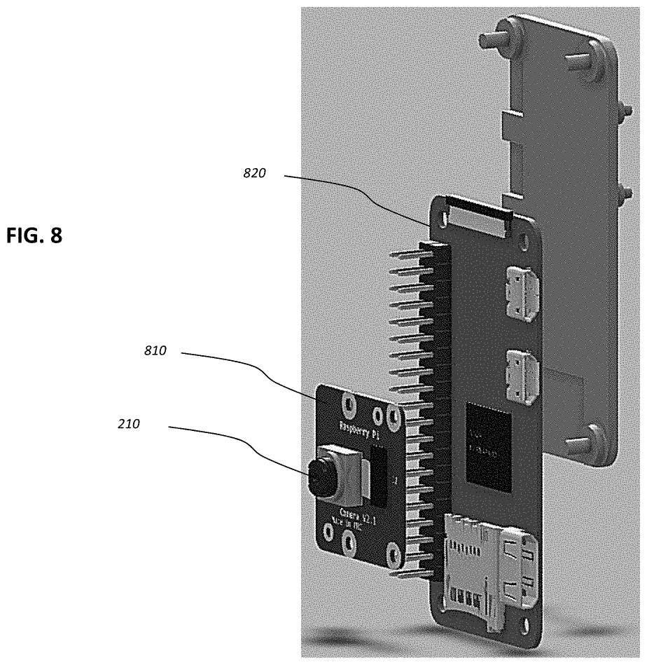

FIG. 8 illustrates an exemplary exploded view of the camera 210, including partial view of some of the electronic components, according to an embodiment of the present disclosure. In some embodiments, the camera 210 may be mounted on a printed circuit board 810, which may be mounted on a printed circuit board 820. The modular design advantageously provide easy upgrades and maintenance.

Turning to FIG. 9, an exemplary user interface screen 900, according to an embodiment of the present disclosure, as viewed by an authorized user, for example, by an Incident Commander at a Command Center, is illustrated. The screen 900 shows real-time locations and other information of multiple camera systems 120 at an emergency location 910.

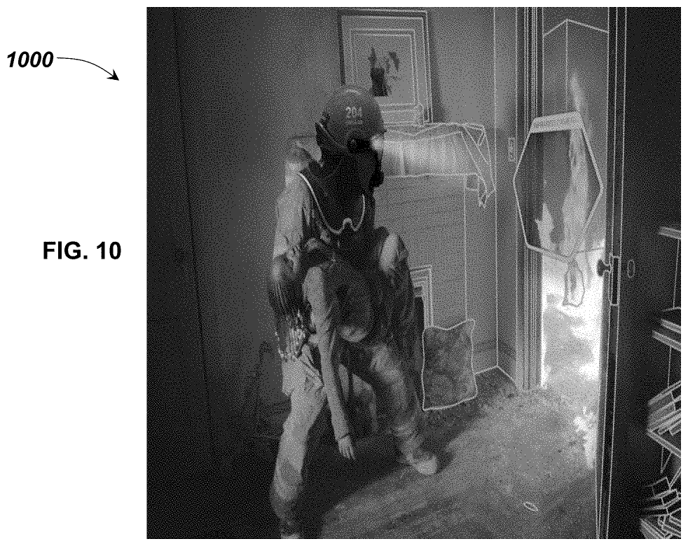

FIG. 10 illustrates an exemplary user interface screen 1000, according to an embodiment of the present disclosure, showing the inside view at a location of an emergency incident. The view is captured and recorded by a camera system 120 located at the scene. The viewer may tap the screen and go to a visual display of the selected area.

FIG. 11 illustrates an exemplary Command Post/Center 1100. Users at the Command Post 1100 may view real-time photos and videos streamed from one or more camera systems 120 located at an incident.

In some embodiments, the camera system 120 may include one or more sensors, and one or more GPS devices. Other components are also contemplated.

As used herein and in the appended claims, the singular forms “a”, “an”, and “the” include plural referents unless the context clearly dictates otherwise.

In the foregoing description and in the figures, like elements are identified with like reference numerals. The use of “e.g.,” “etc.,” and “or” indicates non-exclusive alternatives without limitation, unless otherwise noted. The use of “including” or “include” means “including, but not limited to,” or “include, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

The enablements described above are considered novel over the prior art and are considered critical to the operation of at least one aspect of the invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise. The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

1. A system for acquiring and transmitting visual data from an incident, comprising:
a casing; and
a remotely controllable wireless camera system housed in the casing, the wireless camera system comprises:
a digital camera;
an infrared camera; and
a processor and non-transitory computer readable memory storing instructions that, when executed by the processor:
operate the digital camera and the infrared camera to capture information at the incident;
record the captured information;
transmit the captured information to one or more devices at one or more designated locations; and
automatically switch the capture of information between the digital camera and the infrared camera based on condition at the incident.

2. The system of claim 1, wherein the wireless camera system is turned on remotely.

3. The system of claim 1, wherein the captured information is a video including visual and audio information.

4. The system of claim 1, wherein the captured information is a photo.

5. The system of claim 1, wherein the captured information includes height and depth.

6. The system of claim 1, wherein the captured information includes one or more thermographic images.

7. The system of claim 1, wherein the wireless camera system further comprises a GPS device.

8. The system of claim 1, wherein the wireless camera system further comprises a heat detecting laser device.

9. The system of claim 1, wherein the processor switches the capture of information from the digital camera to the infrared camera when the condition at the incident is smoky or low-light.

10. The system of claim 1, wherein the processor operates the digital camera and the infrared camera to capture information at the incident simultaneously.

11. The system of claim 1, wherein the captured information is transmitted to the one or more devices at the one or more designated locations via a second device at an emergency vehicle and a secured server.

12. The system of claim 1, wherein the processor transmits the captured information to one or more devices at one or more designated locations in real-time.

13. The system of claim 1, wherein the casing is mounted on a helmet.

14. The system of claim 1 is further integrated into a fire department dispatch computer system.

15. A system for acquiring visual data from an incident, comprising:
a remotely controllable wireless camera system having an automatic streaming and non-streaming mode and is coupled to a network wherein the wireless camera system comprises a digital camera and an infrared camera;
one or more user devices coupled to the network, wherein each user device comprises a software package;
an incident management software system;
wherein the remotely controllable wireless camera system further comprises a processor and non-transitory computer readable memory storing instructions that, when executed by the processor:
operate the digital camera and the infrared camera to capture digital and thermographic information at the incident;
record the captured information; and
transmit the captured information to one or more devices at one or more designated locations in real-time.

16. The system of claim 15, wherein the processor further automatically switches the capture of information between the digital camera and the infrared camera based on condition at the incident.

17. The system of claim 15, wherein the processor further operates the digital camera and the infrared camera to capture information at the incident simultaneously.

18. The system of claim 15, wherein the wireless camera system is housed in casing which is mounted on a helmet.

19. The system of claim 15, wherein the wireless camera system further comprises a GPS device.

20. The system of claim 15, wherein the wireless camera system further comprises a heat detecting laser device.
